(19) United States
(12) Patent Application Publication
(10) Pub. No.: US 2011/0028622 A1
(43) Pub. Date: Feb. 3, 2011

(54) POLY(HYDROXYALKANOIC ACID) BLOWN FILM

(75) Inventor: JULIUS URADNISHECK, Glen Mills, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/510,690

(22) Filed: Jul. 28, 2009

(51) Int. Cl. C08K 5/21; C08K 5/09; C08K 5/10; C08K 5/20; C08K 5/092; B29C 49/04

(52) U.S. Cl. 524/211; 524/284; 524/287; 524/300; 524/315; 524/210; 524/321; 524/320; 264/563

(57) ABSTRACT

Disclosed are blown films prepared from poly(hydroxyalkanoic acid) compositions comprising a poly(hydroxyalkanoic acid), an ethylene ester copolymer, and a nucleator.

The invention relates to blown films comprising a poly(hydroxyalkanoic acid) composition.

### BACKGROUND OF THE INVENTION

Poly(hydroxyalkanoic acid) (PHA) resins such as polylactic acid (PLA) comprise renewable monomers such as produced by bacterial fermentation of plant matter that include corn, sugar beets, or sweet potatoes. The resin may be used for transparent oriented (stretched) films, and articles made from the films such as pouches and bags.

However, physical limitations such as brittleness and slow crystallization may limit the applications of PHA. Numerous impact modifiers have been developed in the past to improve the toughness of PHA. For example, JP9316310 discloses a PLA resin composition comprising a modified olefin compound as an impact modifier. Examples of the modified olefin compounds are ethylene-glycidyl methacrylate copolymers grafted with polystyrene, poly(dimethyl methacrylate), etc., and copolymers of ethylene and alpha-olefins grafted with maleic anhydride and maleimide. Toughened PHA compositions are also disclosed in, for example, US2005/0131120A1; U.S. Pat. Nos. 5,883,199, 6,960,374, 6,756,331, 6,713,175, 6,323,308, and 7,078,368; and EP0980894 A1 (films are not transparent).

U.S. Pat. Nos. 7,381,772 and 7,354,973 and US 2007/0213466A1 and US2006/0173133A1 disclose toughened PHA compositions wherein an ethylene ester copolymer (e.g., a terpolymer having copolymerized units of ethylene, butyl acrylate and glycidyl methacrylate (EBAGMA)) is used as an impact modifier.

U.S. Pat. No. 5,756,651 discloses polylactide blends with a degradable impact modifier, such as polycaprolactone or poly(ethylene glycol) and a degradable plasticizer and biaxially oriented films comprising the composition, including blown films.

U.S. Pat. No. 5,849,374 discloses blown films comprising a multilayer structure comprising a core layer of a lactic acid-containing polymer with a glass transition temperature below 20° C. and blocking reducing cover layers.

Films of PHA may also suffer from poor dimensional stability, including shrinkage, when stored or heated above ambient temperatures, such as to 70° C.

The shrinkage force can be due to the presence of stretched PLA molecules not crystallized but amorphous and frozen in place by rapid cooling of the article, termed “amorphous orientation”. When the temperature rises above glass transition temperature (Tg) these molecules relax in a few seconds and induce or cause shrinkage if the article is not constrained from shrinking (i.e. shrinkage-by-relaxation). Amorphous polymers are those that do not crystallize when annealed at a temperature half way between the Tg and the melting temperature (Tm). For example, a random copolymer with a comonomer content greater than about 15% would not crystallize. Other amorphous copolymers may include copolymers of enantiomeric comonomers copolymerized at a 1:1 ratio.

Some additional shrinkage can arise from crystallization (i.e. shrinkage-by-crystallization) if the PLA is not crystallized fully to its capacity during the initial cooling and the temperature of the article is raised considerably above the Tg, especially if the temperature is midway between the Tg and Tm. Such shrinkage-by-crystallization occurs in a few minutes. To solve shrinkage or dimensional stability problems, one may increase crystallinity and/or decrease amorphous orientation. A numerical ratio therefore to be minimized is the amount of amorphous orientation versus total crystallinity.

One may increase the crystallinity or rate of crystallization by use of a nucleator for PLA. Nucleators include talc, calcium silicate, sodium benzoate, calcium titanate, boron nitride, copper phthalocyanine, and isotactic polypropylene (See, e.g., U.S. Pat. No. 6,114,495). Using such nucleators may introduce high haze or opacity to the otherwise transparent PLA films thereby impairing the value of the articles. These nucleators may also interfere with the melt-expansion of the resins during the blown film process. For example, talc can form pinholes in the film preventing it being expanded with internal air pressure.

Other nucleating agents have been developed to increase the crystallinity or rate of crystallization for PHA compositions and therefore improve the dimensional stability and thermal resistance thereof. For example, U.S. Pat. No. 6,417,294 discloses an aliphatic polyester formed item (such as blown film) having transparency and crystallinity in combination by crystallizing, in the course of or after processing, an aliphatic polyester composition comprising aliphatic polyester and one or more transparent nucleating agent selected from the group consisting of aliphatic carboxylic acid amide (e.g., behenamide), aliphatic carboxylic acid salt, aliphatic alcohol and aliphatic carboxylic acid ester having a melting point of 40-300° C. Other nucleators include carboxylic acids or derivatives such as aromatic carboxylic acids, aliphatic carboxylic acids, fatty acid alcohols and fatty acid esters, described in US2008/0306185A1 and US2009/0069509A1.

U.S. Pat. No. 7,301,000 discloses a process for crystallizing a polymer having at least 20 mole percent of hydroxyalkanoate comprising admixing the polymer with an amide compound, such as behenamide, at a temperature from about 5° C. to about 15° C. above the melting point of the polymer and cooling the polymer at a second temperature from about the glass transition temperature of the polymer to about the melting point of the compound.

There is a need for blown films prepared from a PHA-containing composition that has desirable toughness, dimensional stability, and adequate stretchability.

### SUMMARY OF THE INVENTION

A blown film comprises, consists essentially of, consists of, or is produced from, a composition comprising, consisting essentially of, or consisting of, or produced from where R¹ is hydrogen or an alkyl group with 1 to 6 carbon atoms and R² is glycidyl, based on the total weight of the ethylene ester copolymer wherein

the ethylene ester copolymer comprises, based on the total weight of the ethylene ester copolymer, about 20 to about 95% of copolymerized units of ethylene, about 0.5 to about 25% of copolymerized units of one or more olefins of the formula CH₂═C(R¹)CO₂R², and 0 to about 70% of copolymerized units of one or more olefins of the formula CH₂═C(R³)CO₂R⁴;

R¹ is hydrogen or an alkyl group with 1 to 6 carbon atoms;

R² is glycidyl, based on the total weight of the ethylene ester copolymer;

R³ is hydrogen or an alkyl group with 1 to 8 carbon atoms;

R⁴ is an alkyl group with 1 to 8 carbon atoms, carbon monoxide, or of two or more combinations thereof;

the nucleator is a carboxylic acid or derivative thereof that does not cause PHA depolymerization.

The invention also provides a process for preparing a blown film comprising: contacting a poly(hydroxyalkanoic acid) with a combination of nucleator and ethylene copolymer to produce a compound comprising the comprising described above; extruding the compound upward through a thin annular die opening as a melt to form a tube; introducing air through the center of the die to inflate the tube and thereby causing it to expand at or above the melting point (Tm); and cooling the tube by air blown through one or more chill rings surrounding the tube to produce a blown film comprising the compound.

### DETAILED DESCRIPTION OF THE INVENTION

The modified PHA composition described herein is suitable for preparing blown films with greater crystallinity than the corresponding nonmodified PHA. The greater crystallinity provides an ability to provide improved dimensional stability when these films are stretched and heat set for a short period of time. That is, a stretched film prepared from the modified PHA composition shrinks less when exposed to elevated temperatures compared to a film prepared from nonmodified PHA treated in the same manner.

The PHA polymers suitable for use in the compositions may be prepared by polymerization of hydroxyalkanoic acids having 2 to 15, 2 to 10, 2 to 7, or 2 to 5, carbon atoms. Examples of hydroxyalkanoic acids include 6-hydroxyhexanoic acid, 3-hydroxyhexanoic acid, 4-hydroxyhexanoic acid, 3-hydroxyheptanoic acid, glycolic acid, lactic acid, 3-hydroxypropionic acid, 2-hydroxybutyric acid, 3-hydroxybutyric acid, 4-hydroxybutyric acid, 3-hydroxyvaleric acid, 4-hydroxyvaleric acid, and 5-hydroxyvaleric acid, or combinations of two or more thereof. The PHA is preferably derived from the polymerization of hydroxyalkanoic acids (or esters thereof) having 2 to 5 carbon atoms, such as glycolic acid, lactic acid, 3-hydroxypropionic acid, 2-hydroxybutyric acid, 3-hydroxybutyric acid, 4-hydroxybutyric acid, 3-hydroxyvaleric acid, 4-hydroxyvaleric acid, or 5-hydroxyvaleric acid. Other poly(hydroxyalkanoic acids) may be prepared by polymerization of 6-hydroxyhexanoic acid (also known as polycaprolactone (PCL)), 3-hydroxyhexanoic acid, 4-hydroxyhexanoic acid, or 3-hydroxyheptanoic acid. Examples of polymers include poly(glycolic acid) (PGA), poly(lactic acid) (PLA), poly(hydroxybutyric acid) (PHB), polycaprolactone (PCL), or combinations of two or more thereof, including blends of two or more PHA polymers (e.g., blend of PHB and PCL) that are desirably crystallizable.

The PHA used as components of the compositions may be homopolymers or copolymers comprising at least one comonomer derived from a hydroxyalkanoic acid or a derivative thereof. By derivative is meant a hydroxyalkanoate or a cyclic dimer (e.g., a lactide dimer) derived from the reaction between two hydroxyalkanoic acids.

The PHA polymers may also be copolymers of one or more hydroxyalkanoic acid monomers or derivatives with other comonomers, such as aliphatic and aromatic diacid and diol monomers (e.g., succinic acid, adipic acid, terephthalic acid, ethylene glycol, 1,3-propanediol, and 1,4-butanediol).

Blends of such polymers are also useful. For example, the PHA polymer may be a blend of copolymers of such as poly(hydroxybutyric acid-hydroxyvaleric acid) copolymers and poly(glycolic acid-lactic acid) copolymers. Such copolymers can be prepared by catalyzed copolymerization of a PHA or derivative with one or more comonomers derived from cyclic esters and/or dimeric cyclic esters. Such esters may include glycolide (1,4-dioxane-2,5-dione); the dimeric cyclic ester of glycolic acid; lactide (3,6-dimethyl-1,4-dioxane-2,5-dione); α,α-dimethyl-β-propiolactone; the cyclic ester of 2,2-dimethyl-3-hydroxy-propanoic acid; β-butyrolactone; the cyclic ester of 3-hydroxybutyric acid; δ-valerolactone; the cyclic ester of 5-hydroxypentanoic acid; ε-capro-lactone; the cyclic ester of 6-hydroxyhexanoic acid; the lactone of the methyl substituted derivatives of 6-hydroxyhexanoic acid (such as 2-methyl-6-hydroxyhexanoic acid, 3-methyl-6-hydroxyhexanoic acid, 4-methyl-6-hydroxyhexanoic acid, 3,3,5-trimethyl-6-hydroxyhexanoic acid, and etc.); the cyclic ester of 12-hydroxy-dodecanoic acid and 2-p-dioxanone; and the cyclic ester of 2-(2-hydroxyethyl)-glycolic acid.

Of note are PHA polymers wherein the PHA is selected from the group consisting of poly(glycolic acids), poly(lactic acids), poly(hydroxybutyric acids), poly(hydroxybutyric acid-hydroxyvaleric acid) copolymers, and poly(glycolic acid-lactic acid) copolymers. Preferably, the PHA is selected from poly(glycolic acid), PLA, poly(hydroxybutyrate) and combinations of two or more of these polymers. More preferably, the PHA is a PLA having a number average molecular weight (Mₙ) of about 3,000 to about 1,000,000. Preferably Mₙ is about 10,000 to about 700,000, more preferably about 20,000 to about 600,000.

The PLA may be a homopolymer or a copolymer containing at least about 50 mol %, or at least about 70 mol %, or at least about 90 mol % of copolymerized units derived from lactic acid or derivatives thereof. The PLA homopolymers or copolymers can be prepared from the two optical monomers D-lactic acid and L-lactic acid, or a mixture thereof (including a racemic mixture thereof). Either D- or L-lactic acid can be produced in synthetic processes, whereas fermentation processes usually (but not always) tend to favor production of the L enantiomer. The PLA copolymer may be a random copolymer or a block copolymer or a stereo block copolymer or a stereo complex between optical blocks. For example, the PLA copolymer may be the stereo complex of about 50% of poly(D-lactic acid) and about 50% of poly(L-lactic acid). Alternatively, the PLA copolymer may be a copolymer in which the average enantiomer ratios may be from 70:30 to 97:3 or greater, such as from 80:20 to 90:10 or 95:3 or greater. Blends of copolymers having different enatiomer ratios may also be used to provide a resin with an enantiomer ratio in a desired range. Of note are compositions (either copolymers or blends) wherein one enantiomer constitutes 90-99.5% of the polymerized lactic acid units and the other enantiomer constitutes from 0.5 to 10% of the polymerized lactic acid units.

The PHA may be prepared by any suitable process. For example, the PHA may be prepared by a direct dehydration-polycondensation process which involves the dehydration and condensation of the hydroxyalkanoic acid(s) in the presence of an organic solvent and catalyst (see e.g., U.S. Pat. Nos. 5,310,865 and 5,401,796). A PHA may also be synthesized through the dealcoholization-polycondensation of an alkyl ester of polyglycolic acid or by ring-opening polymerization of a cyclic derivative such as the corresponding lactone or cyclic dimeric ester (see e.g., U.S. Pat. No. 2,703,316). A preferred lactide is produced by polymerizing lactic acid to form a prepolymer, and then depolymerizing the prepolymer and simultaneously distilling off the lactide that is generated, described in U.S. Pat. No. 5,274,073.

PHA may be produced by bulk polymerization. The bulk polymerization may be carried out by two production processes, i.e., a continuous process and a batch process. JP03-502115A discloses a process wherein bulk polymerization for cyclic esters is carried out in a twin-screw extruder. JP07-26001A discloses a process for the polymerization for biodegradable polymers, wherein a bimolecular cyclic ester of hydroxycarboxylic acid and one or more lactones are continuously fed to a continuous reaction apparatus having a static mixer for ring-opening polymerization. JP07-53684A discloses a process for the continuous polymerization for aliphatic polyesters, wherein a cyclic dimer of hydroxycarboxylic acid is fed together with a catalyst to an initial polymerization step, and then continuously fed to a subsequent polymerization step built up of a multiple screw kneader. See, e.g., U.S. Pat. Nos. 2,668,162 and 3,297,033.

PHA polymers and copolymers may also be made by living organisms or isolated from plant matter. Numerous microorganisms have the ability to accumulate intracellular reserves of PHA polymers. For example, copolymer poly(3-hydroxybutyrate-co-3-hydroxyvalerate) (PHB/V) has been produced by fermentation of the bacterium Ralstonia eutropha. Fermentation and recovery processes for other PHA types have also been developed using a range of bacteria including Azotobacter, Alcaligenes latus, Comamonas testosterone and genetically engineered E. coli and Klebsiella. U.S. Pat. No. 6,323,010 discloses a number of PHA copolymers prepared from genetically modified organisms.

Glycolic acid is derived from sugar cane. Poly(glycolic acid) may be synthesized by the ring-opening polymerization of glycolide and is sometimes referred to as poly-glycolide.

PHA also includes copolymers comprising more than one hydroxyalkanoic acid, such as polyhydroxybutyrate-hydroxyvalerate (PHB/V) copolymers and copolymers of glycolic acid and lactic acid (PGA/LA). Copolymers may be produced by copolymerization of a polyhydroxyalkanoic acid or derivative with one or more cyclic esters and/or dimeric cyclic esters. Such comonomers include glycolide (1,4-dioxane-2,5-dione), dimeric cyclic ester of glycolic acid, lactide (3,6-dimethyl-1,4-dioxane-2,5-dione), α,α-dimethyl-β-propiolactone, cyclic ester of 2,2-dimethyl-3-hydroxypropanoic acid, β-butyrolactone, cyclic ester of 3-hydroxybutyric acid, δ-valerolactone, cyclic ester of 5-hydroxypentanoic acid, ε-caprolactone, cyclic ester of 6-hydroxyhexanoic acid, and lactone of its methyl substituted derivatives, such as 2-methyl-6-hydroxyhexanoic acid, 3-methyl-6-hydroxyhexanoic acid, 4-methyl-6-hydroxyhexanoic acid, 3,3,5-trimethyl-6-hydroxyhexanoic acid, etc., cyclic ester of 12-hydroxy-dodecanoic acid, and 2-p-dioxanone, cyclic ester of 2-(2-hydroxyethyl)-glycolic acid, or combinations of two or more thereof. Copolymers may also be prepared by the reaction of two or more homopolymers of PHA in the presence of an organic solvent (see e.g., EP712880A2).

PHA compositions also include copolymers of one or more PHA monomers or derivatives with other comonomers, including aliphatic and aromatic diacid and diol monomers such as succinic acid, adipic acid, and terephthalic acid and ethylene glycol, 1,3-propanediol, and 1,4-butanediol. About 100 different comonomers have been incorporated into PHA polymers. The more moles of comonomer(s) incorporated in the copolymer, the less likely the copolymer is to crystallize. Crystalline copolymers may be crystallized by dissolving into an organic solvent and subsequent precipitation from it. Less crystalline copolymers may be crystallized when melt-blended with a nucleator.

PLA includes PLA homopolymers and copolymers of lactic acid and other monomers containing at least 50 mole % (50% comonomer gives the least likely random copolymer composition to crystallize, no matter what heat treatment conditions) of copolymerized units derived from lactic acid or its derivatives (mixtures thereof) having a number average molecular weight of 3000 to 1000000, 10000 to 700000, or 20000 to 300000. PLA may contain at least 70 mole % of copolymerized units derived from (e.g. made by) lactic acid or its derivatives. The lactic acid monomer for PLA homopolymers and copolymers may be derived from d-lactic acid, l-lactic acid, or combinations thereof. A combination of two or more PLA polymers may be used. PLA may be produced by catalyzed ring-opening polymerization of the dimeric cyclic ester of lactic acid, which is frequently referred to as “lactide.” As a result, PLA is also referred to as “polylactide”.

PLA also includes the special class of copolymers and blends of different stereo-isomers of lactic acid or lactide. Melt blends of PLA polymerized from d-lactic acid or d-lactide and PLA polymerized from l-lactic acid or l-lactide may give a stereo-complex between the two stereopure PLAs at a 50/50 ratio. Crystals of the stereo-complex itself have a much higher melt point than either of the two PLA ingredients. Similarly, stereo-block PLA may be solid state polymerized from low molecular weight stereo-complex PLA.

Copolymers of lactic acid may be prepared by catalyzed copolymerization of lactic acid, lactide or another lactic acid derivative with one or more cyclic esters and/or dimeric cyclic esters as described above.

The PHA composition may comprise 0.05 to about 5%, about 0.1 to about 4%, about 0.5 to about 4%, about 1 to about 4%, about 0.5 to about 3%, about 1 to about 3%, or about 1 to about 2%, based on the weight of the composition, of a nucleator, which can include a carboxylic acid or derivative thereof that does not cause PHA depolymerization. The carboxylic acid or its derivative can include aromatic carboxylic acid (e.g., benzoic acid); aliphatic carboxylic acid (e.g., unsaturated fatty acid such as oleic acid; saturated fatty acid such as stearic acid and behenic acid; fatty acid alcohol (an alcohol prepared from a fatty acid by reduction) such as stearyl alcohol; fatty acid aliphatic carboxylic acid ester such as butyl stearate; and aliphatic carboxylic acid amide such as stearamide, ethylene bis-stearamide or behenamide; polycarboxylic acid; aliphatic hydroxycarboxylic acid; or combinations of two or more thereof. Wishing not to be bound by theory, blown films made from a PHA composition comprising long chain (e.g., ≧31 carbons) fatty acids or derivatives may be less optically clear due to possible difficulty in dispersing these compounds or due to less solubility of these compounds in PHA such as above about 2% and due to a mismatch of refractive indices of the PHA and additives.

The carboxylic acids or their derivatives can be aliphatic, mono-functional (saturated, unsaturated, or multi-unsaturated) carboxylic acids or derivatives thereof. The acid may have from about 10 to about 30, about 12 to about 28, about 16 to about 26, or 18 to 22, carbon atoms per molecule. Of particular interest are those on the US Food and Drug Administration (FDA) list as GRAS (generally regarded as safe) or having food contact status. The carboxylic acid derivatives may have a low volatility (do not volatilize at temperatures of melt blending with PHA) when being melt-blended with PHA or have particles that can well dispersed in PHA such as those having diameters less than about 2μ or are non-migratory (do not bloom to the surface of PLA under normal storage conditions (ambient temperatures)). That is, a desired carboxylic acid or derivative has a boiling point higher than the melt processing temperature and pressure of the PHA, which is disclosed elsewhere in the application.

Examples of carboxylic acid nucleators include lauric acid, palmitic acid, stearic acid, behenic acid, erucic acid, oleic acid, linoleic acid, or combinations of two or more thereof.

Fatty acid ester nucleators include alkyl esters of a fatty acid where the alkyl ester moiety has 1 to 30, 4 to 30, 1 to 20, 4 to 20, or 10 to 20 carbon atoms and the fatty acid moiety has from 10 to 30, 12 to 28, 16 to 26, or 18 to 22, carbon atoms. These nucleators include C₁ to C₈, preferably C₁ to C₄, alkyl esters of lauric, palmitic, stearic, erucic, oleic, linoleic, or behenic acids.

Aliphatic carboxylic acid amides suitable for use as the nucleator component of the compositions include those selected from the group consisting of aliphatic monocarboxylic acid amides, N-substituted aliphatic monocarboxylic acid amides, aliphatic carboxylic acid bisamides, N-substituted aliphatic carboxylic acid bisamides, and N-substituted ureas and mixtures thereof. Examples include amides of aliphatic carboxylic acids wherein the acid has 10 to 30 carbon atoms, preferably 12 to 28 carbon atoms, more preferably 16 to 26 carbon atoms, and most preferably 18 to 22 carbon atoms.

Aliphatic carboxylic acid amides which are useful in the composition include, but are not limited to a) aliphatic monocarboxylic acid amides (e.g., lauramide, palmitamide, oleamide, stearamide, erucamide, behenamide, ricinolamide, hydroxystearamide), b) N-substituted aliphatic monocarboxylic acid amides (e.g., N-oleylpalmitamide, N-oleyloleamide, N-oleylstearamide, N-stearyloleamide, N-stearylstearamide, N-stearylerucamide, methylolstearamide, methylolbehenamide), c) aliphatic carboxylic acid bisamides (e.g., methylenebisstearamide, ethylenebislauramide, ethylenebiscapramide, ethylenebisoleamide, ethylenebisstearamide, ethylenebiserucamide, ethylenebisbehenamide, ethylenebisisostearamide, ethylenebishydroxystearamide, butylenebisstearamide, hexamethylenebisoleamide, hexamethylenebisstearamide, hexamethylenebisbehenamide, hexamethylenebis hydroxystearamide, m-xylylenebisstearamide, m-xylylenebis-12-hydroxystearamide), d) N-substituted aliphatic carboxylic acid bisamides (e.g., N,N′-dioleylsebacamide, N,N′-dioleyladipamide, N,N′-distearyladipamide, N,N′-distearylsebacamide), and e) N-substituted ureas (e.g., N-butyl-N′-stearylurea, N-propyl-N′-stearylurea, N-allyl-N′-stearylurea, N-phenyl-N′-stearylurea, xylylenebisstearylurea, tolylenebisstearylurea, hexamethylenebisstearylurea, diphenylmethanebisstearylurea, diphenylmethanebislaurylurea). These aliphatic carboxylic acid amides can be used singly or as a mixture.

Examples of nucleators include lauramide, palmitamide, stearamide, erucamide, oleamide, linoleamide, behenamide, arachidamide, ethylene bis-stearamide, or combinations of two or more thereof.

The aliphatic carboxylic acid amide is preferably an aliphatic monocarboxylic acid amide. More preferably, the aliphatic carboxylic acid amide is selected from erucamide, behenamide and stearamide. Most preferably, the aliphatic carboxylic acid amide is behenamide.

The carboxylic acid or derivative may be present in a sufficiently high (or greater than 0.1%) crystallization-improving amount thereby providing heat resistance at 55° C., 70° C. or above. Not to be bound by theory, if the carboxylic acid derivative is present at too high a level, it may cause the melt blend viscosity and melt strength to be too low or unstable for subsequent processing into pellets, film, sheeting, or other articles. For example, pellets of a concentrate of behenamide in PLA may be formed via under-water pelletization if the nucleator additive level is less than about 20%. Above 20% the viscosity may be too unstable for pelletization. Furthermore the size of nucleator particles having unmatched refractive indexes with the PHA may be less than about 500 nm, less than about 300 nm, or even less than 80 nm for low haze. The difficulty of dispersing nucleator to small sizes may increase with amount of nucleator used and its solubility in the PHA. In general more than about 2% nucleator in the PHA may lead to hazy blends. For example, more than 3% or more than about 5% may give too high a level of haze irrespective of the type of mixing used.

The composition also includes an ethylene copolymer as an impact modifier or toughener, which makes the composition less brittle. The ethylene copolymer is made by copolymerizing units (monomers) of (a) ethylene; (b) one or more olefins of the formula CH₂═C(R¹)CO₂R² where R¹ is hydrogen or an alkyl group with 1 to 6 carbon atoms, such as methyl, and R² is glycidyl; and optionally (c) one or more olefins of the formula CH₂═C(R³)CO₂R⁴, where R³ is hydrogen or an alkyl group with 1 to 8 carbon atoms and R⁴ is an alkyl group with 1 to 8 carbon atoms, such as methyl, ethyl, or butyl, carbon monoxide, or combinations thereof. Copolymerized units derived from monomer (a) may comprise, based on the copolymer weight, from about 20, 40 or 50% to about 80, 90 or 95%. Copolymerized units derived from monomer (b) may comprise, based on the copolymer weight, from about 0.5, 2 or 3% to about 17, 20, or 25%. An example of the ethylene copolymer consists essentially of copolymerized units of ethylene and copolymerized units of glycidyl methacrylate and is referred to as EGMA. Optional monomers (c) may be butyl acrylates or CO. One or more of n-butyl acrylate, tert-butyl acrylate, iso-butyl acrylate, and sec-butyl acrylate may be used. An ethylene copolymer example consists essentially of copolymerized units of ethylene, copolymerized units of butyl acrylate, and copolymerized units of glycidyl methacrylate (EBAGMA) as well as of ethylene, copolymerized units of methacrylate, and copolymerized units of glycidyl methacrylate (EMAGMA). Copolymerized units derived from monomer (c), when present, may comprise, based on the copolymer weight, from about 3, 15 or 20% to about 35, 40 or 70%.

Of note are compositions and blown films wherein the ethylene ester copolymer is selected from the group consisting of ethylene/glycidyl methacrylate copolymers, ethylene/butyl acrylate/glycidyl methacrylate terpolymers, and mixtures thereof, and wherein the ethylene ester copolymer is an ethylene/butyl acrylate/glycidyl methacrylate terpolymer.

The ethylene ester copolymers may be prepared by any suitable process such as those disclosed in U.S. Pat. Nos. 3,350,372; 3,756,996; 5,532,066; 5,543,233; and 5,571,878. Alternatively the ethylene copolymer may be a glycidyl methacrylate grafted ethylene copolymer or polyolefin, wherein an existing ethylene copolymer such as ethylene/methyl acrylate copolymer or a polyolefin such as polyethylene is reacted with glycidyl methacrylate to provide a copolymer with units derived from glycidyl methacrylate pendant from the polymer chain.

The PHA composition may comprise one or more additives including plasticizers, stabilizers, antioxidants, ultraviolet ray absorbers, hydrolytic stabilizers, anti-static agents, dyes or pigments, fillers, fire-retardants, lubricants, reinforcing agents such as flakes, processing aids, antiblock agents, release agents, and/or combinations of two or more thereof. These additives may be present in the compositions, by weight, from 0.001 to 25%, or 0.01 to 2% of the total composition, provided if the additive has a melting point at least 20° C. above the melting point of the PHA, that additive is kept below 1%. The compositions may contain from about 0.5 to about 5% plasticizer; from about 0.1 to about 2% antioxidants and stabilizers; from about 3 to about 10% other solid additives; from about 0.5 to about 20% nanocomposite; and/or from about 1 to about 20 weight % flame retardants.

Particular embodiments of the blown film include those wherein the composition comprises about 67 to about 99 weight % of the PHA, about 0.5 to about 20 weight % of the ethylene ester copolymer, and about 0.1 to about 3 weight % of the aliphatic carboxylic acid amide, based on the total weight of the composition, and those wherein the composition comprises about 89 to about 99 weight % of PLA, about 1 to about 10 weight % of ethylene/butyl acrylate/glycidyl methacrylate terpolymer and about 0.25 to about 1 weight % of behenamide, based on the total weight of the composition.

A blown film process comprises contacting a PHA composition or PHA with a combination of nucleator and ethylene copolymer as defined above to produce a compound. The contacting may include mixing PHA, nucleator and ethylene copolymer until the nucleator and ethylene copolymer are substantially or even homogeneously dispersed. Any mixing methods known in the art may be used. For example, the component materials may be mixed to be substantially dispersed or homogeneous using a melt-mixer such as a single or twin-screw extruder, blender, Buss Kneader, double helix Atlantic mixer, Banbury mixer, roll mixer, etc., to give a resin composition.

The contacting may include a melt-mixing temperature in the range above the softening point of the PHA and below the depolymerization temperature of the PHA; that is, about 100° C. to about 400° C., about 170° C. to about 270° C., or about 180° C. to about 230° C. at an ambient pressure or in the range of 0 to about 60 MPa or 0 to about 34 MPa. The condition creates sufficiently high shear history to disperse the nucleator and ethylene copolymer into small particles and distribute them uniformly through the melted PHA and sufficiently low shear history to avoid excessive loss of PHA molecular weight and its embrittlement.

Shear history is the concept of the amount of shear over a duration of time. A melt experiences more shear history when it experiences high shear for a long time than when it experiences high shear for a short time. Similarly a melt experiences more shear history when it experiences medium shear for a time than when it experiences very low shear for a short time or when it experiences very low shear for a long time. The shear history of plastics processing equipment may be complicated by differing shear rates and duration times within the equipment. For example, in a single screw extruder producing pellets, the screw has low shear rates and long durations within the channels of the screw but high screw rates and low durations between the top of the screw flight and the walls of the extruder.

For example, an insufficiently high shear history may be achieved by use of less than about 2 minutes of mixing from introduction of the ambient temperature ingredients into a heated twin-blade batch mixer using rotor blade mixers that may be co- or counter-rotating, or the use of a 10:1 length to diameter (L:D) ratio trilobal, co-rotating twin screw continuous extruder using a screw that contains less than 10% total length of screw elements that are either kneading blocks or reverse elements, the rest being forward conveying sections. A sufficiently high shear history may result from use of at least 3 minutes on the batch mixer, or at least 20:1 L:D ratio on the extruder. An excessively high shear history may result from more than 15 minutes in the batch unit or a 50:1 L:D ratio in the extruder. Other processing equipment may be used for melt mixing such as a single screw extruder, counter rotating twin screw extruder, or roll mill. Also useful processors may include bilobal twin screw extruders and single screw extruders with mixing torpedoes at the end of the screw.

A portion of the component materials may be mixed in a melt-mixer, and the rest of the component materials subsequently added and further melt-mixed until substantially dispersed or homogeneous. For example, the combination of the nucleator and the ethylene copolymer may be melt mixed to form a concentrate or master batch of the nucleator in the ethylene copolymer that may comprise, by weight of the composition, 2 to 80%, 5 to 50%, 25 to 75%, or 10 to 25% of the carboxylic acid derivative nucleator. Of note is a master batch comprising 50 weight % of the nucleator and 50 weight % of the ethylene copolymer. The master batch may be subsequently added to the PHA resin to form the modified PHA composition used to prepare the blown films.

Alternatively, the nucleator may be melt mixed with PHA to provide a concentrate of 2 to 80, 5 to 50%, or 10 to 25% of the nucleator in PHA. The nucleated PHA may be combined with additional PHA and/or the ethylene copolymer to form the modified PHA composition.

In blown film extrusion, also referred to as tubular film extrusion, the composition is extruded upward through a thin annular die opening as a melt. Air is introduced through the center of the die to inflate the tube and thereby causing it to expand at or above the melting point (Tm); as a liquid in other words.

A moving bubble is thus formed which is held at a constant size by control of internal air pressure. The tube of film is cooled by air, blown through one or more chill rings surrounding the tube. The tube is then collapsed by drawing it into a flattening frame through a pair of pull rolls and into a winder. The flattened tubular film may be subsequently slit open, unfolded to form a flat film, and optionally further slit into widths appropriate for use in products.

Blown films have some degree of biaxial orientation which provides improved mechanical properties in most packaging applications. The blowing process orients the molecules in the transverse direction due to horizontal stretching of the film. “Blowup ratio” is the ratio of the diameter of the blown film bubble size to the diameter of the die through which the blend is extruded. The blowup ratio may range from about 1:1 to about 7:1. The extent of biaxial orientation in the transverse direction is related to the blowup ratio.

The blowing process may also orient the molecules in the machine direction due to vertical stretching of the film. Vertical stretching results when the take-up speed of the tubular film exceeds the extrusion speed and is sometimes called machine direction drawdown. The extent of machine direction orientation is determined by the velocity of the take-off rolls relative to the linear extrusion speed and is described by the drawdown ratio. “Drawdown ratio” is the machine direction analog to the blowup ratio and may range from about 2:1 to about 40:1.

Because the desired optimization of mechanical properties is achieved by biaxial orientation, the desired degree of orientation in either the transverse or machine directions may be achieved by independent adjustment of the blowup ratio and drawdown ratio (i.e., the take-off speed). Blowup ratios may range from about 1:1 to about 6:1, or from about 2:1 to about 5:1, such as about 4:1. The drawdown ratio may range from about 2:1 to about 40:1, or from about 4:1 to about 20:1, such as about 10:1.

A blown film may be oriented using a double bubble extrusion process, where simultaneous biaxial orientation may be effected. The double-bubble process first quenches the initially blown tube, and it is then reheated and oriented by inflating at a temperature above the Tg but below the crystalline melting point (if the polymer is crystalline). The orientation occurs when the tube is expanded by internal gas pressure to induce transverse orientation, and drawn by differential speed nip or conveying rollers at a rate which may induce longitudinal orientation.

The double bubble technique can be carried out as disclosed in U.S. Pat. No. 3,456,044. A primary tube can be melt extruded from an annular die. This extruded primary tube can be cooled quickly to minimize crystallization. It can be then heated to its orientation temperature (for example, by means of a water bath or infrared heaters). In the orientation zone of the film fabrication unit a secondary tube is formed by inflation, thereby the film is radially expanded in the transverse direction and pulled or stretched in the machine direction at a temperature such that expansion occurs in both directions, preferably simultaneously; the expansion of the tubing being accompanied by a sharp, sudden reduction of thickness at the draw point. The tubular film is then again flattened through nip rolls. The film can be reinflated and passed through an annealing step (thermofixation), during which step it is heated once more to adjust the shrink properties.

The initial blown film may also be further oriented uniaxially by heating the film at a temperature above the Tg but below the crystalline melting point (if the polymer is crystalline) and stretching it. The tubular blown film is slit open, unfolded to provide a flat film, passed through a short heating zone, such as an oven, and oriented (stretched) in one direction using rollers running at different speeds. For example, a 3× to 6 one-way orientation is obtained by running the take-up roll 3 to 6× faster than the feed roll. Line speeds may be typically 50 m/minute to 100 m/minute for film being stretched. Unless heat-set, the resulting film has shrinkage above Tg. This is not desirable because Tg is close to ambient temperatures for many PHA polymers. To reduce or even avoid shrinkage, one can heat set (anneal) the film by exposing it to heat while under tension. As indicated above, the cause of poor dimensional stability may be due to shrinkage-by-crystallization and also may be due to shrinkage-by-relaxation of stretched amorphous molecules. Heat setting under tension allows for more complete crystallization and also allows for stretched amorphous molecules to become relaxed but remain amorphous. The oven through which the film is traveling would have to be very long if the heat-set duration were more than about 10 seconds.

In either the double bubble process or the uniaxial stretching process, faster crystallization times are desirable to provide low-shrink properties with minimal heat-set duration. The compositions described herein provide for blown films that can be heat-set with short annealing times.

A multilayer structure such as a multilayer blown film may be made from a layer comprising the modified PHA composition and at least one other layer comprising a composition other than the modified PHA composition. For example, additional layers may comprise or be produced from thermoplastic resins, to which the layer made from the composition is adhered.

A multilayer blown film can be prepared by coextrusion, e.g., melting granulates of the various components in separate extruders; passing the molten polymers through a mixing block that joins the separate polymer melt streams into one melt stream containing multiple layers of the various components; and flowing the melt stream into an annular die or set of dies to form layers of molten polymers that are processed as a multilayer flow. The multilayer structure can be oriented and optionally heat set as described above.

The orientation of the layers can be modified to provide desired physical properties. For example, the physical properties of a multilayer film prepared by blown film coextrusion may be altered by adjusting the blow-up-ratio (BUR; the ratio of the diameter of the film bubble to the die diameter). For purposes of providing a bag or wrapper, it is desirable to provide a BUR of between about 1 and 5, determined based upon the desired balance of properties in the machine direction and the tensile direction. For a balanced multilayer film, a preferred BUR of about 3:1 is appropriate. Alternately, it may be desirable to have a “splitty” film which easily tears in one direction (such as the machine direction) and tears less easily in the other direction. Lower BUR, such as about 1:1 to 1.5:1 may provide a multilayer structure with these tear properties.

The multilayer polymeric sheet can involve at least three categorical layers including, but not limited to, an outermost structural or abuse layer, an inner barrier or gas control layer, bulking layer and/or adhesive layer, and an innermost sealant layer making contact with and compatible with the intended contents of the package and capable of forming the necessary seals (e.g. most preferably heat-sealable) to itself and the other parts of the package. Other layers may also be present to serve as adhesive or “tie” layers to help bond these layers together.

The outermost structural or abuse layer, when optically transparent, preferably is reverse printable and unaffected by the sealing temperatures used to make the package, since the package is sealed through the entire thickness of the multilayer structure. When the outer structural or abuse layer is not optically transparent, this layer can be surface printed and then optionally coated with a protective coating or lacquer. The thickness of this layer can control the stiffness of the film, and may range from about 10 to about 100 μm or from about 12 um to about 50 μm.

The inner layer can include one or more barrier layers, depending on which atmospheric conditions (oxygen, humidity, light, and the like) can potentially affect the product inside the package. Barrier layers can be, for example, metallized PP or PET), polyethylene vinyl alcohol (EVOH), polyvinyl alcohol, polyvinylidene chloride, polyolefins, aluminum foil, nylon, blends or composites of the same as well as related copolymers thereof. Barrier layer thickness may depend on factors such as the sensitivity of the product and the desired shelf life.

The inner layer can include one or more bulking layers. This layer is usually added to create a structure that has a final, predefined thickness by using a common polymer that is of low cost. Bulking layers can be, for example, polyolefin, polyolefin polar copolymer, polyester and or blends of various bulking layer components. A bulking layer is also suitable for incorporation of regrind and scrap generated in the manufacturing process. For example, scrap generated from material that, for one reason or another, is not suitable for sale, or material that is generated by trimming the edges off a semi-finished roll, can be ground up and incorporated into the inner layer providing bulk at relatively low cost.

The inner layer can include one or more adhesive layers. This adhesive layer is usually designed to adhere the outer structural layer to the inner layer, the inner layer to the innermost layer or, in the case where the inner layer may only be acting as an adhesive, bonding the outer layer directly to the innermost layer.

A multilayer structure may also be made by (co)extrusion followed by lamination to one or more other layers. For example, a first film, such as a blown film described above, may be laminated to a second film or substrate by applying a thin curtain of molten adhesive (or tie) layer composition, between the two film substrates and passing the layered structure through a nip between a pressure roll and a chill roll. Extrusion coating may also be used, in which a thin curtain of a coating composition is applied to the surface of a substrate, such as a blown film prepared as described above, and the resulting multilayer structure is passed through a nip between a pressure roll and a chill roll.

### EXAMPLES

The following Examples are illustrative, and are not to be construed as limiting the scope of the invention. They illustrate making blown films of the nucleated PHA composition. In the tables, “NM” means not measured.

### Materials

PLA-1: a PLA homopolymer with a Tg of 58° C., a melt point maximum endotherm at 166° C., and heat-up crystallinity of about 6 J/g (generated with a second 10° C./minute heating of pellets previously heated to complete melting at 250° C. and cooled to 20° C.), purchased from NatureWorks LLC (Minnetonka, Minn. USA) as PLA4032D pellets.

Behenamide: Two grades were used.

CRODAMIDE® BR available as “refined behenamide” from Croda Inc., Edison, N.J., with melting point of 225 J/g at 119° C.

KEMAMIDE® B: a behenamide composition available from Chemtura Corporation, Middlebury, Conn., with melting point of 240 J/g at 114° C.

EBAGMA-1: an autoclave-produced ethylene/n-butyl acrylate/glycidyl methacrylate terpolymer (comonomer ratio 66.75 weight % ethylene, 28 weight % n-butyl acrylate, 5.25 weight % glycidyl methacrylate) melt index 12 g/10 minutes, 190° C., 2.16 kg load, melting range 50° C. to 80° C.

Mod-1: A melt blend of a 1:1 (by weight) mixture of EBAGMA-1 and CRODAMIDE® BR, extruded and formed into pellets.

### Analytical Equipment and Methods

Pellets of PLA-1 and modifiers were dry blended in the amounts shown in Table 1 and blown films were made as follows.

The pellets were extruded into blown film using a 1.9-cm single (25:1 L:D) screw extruder sold by C.W. Brabender Instruments, Inc (South Hackensack, N.J.) feeding a circular die (2.5 cm diameter). The 50-cm long screw had an 8-cm mixing section at its terminus. Take-off speed was about 2 inches/second. The barrel was set to 200° C. and with the screw operating at 27 rpm, and the melt temperature was 205° C. These films were made in a way that their increase of diameter appeared to happen before the frost line was created, i.e., orientation occurred at or above the melt temperature of the composition, when it was still liquid.

TABLE 1

| | Weight % | | | Dimensions | |
|---|---|---|---|---|---|
| | | | Kemamide | | Thickness |
| Example | Mod-1 | EBAGMA | B ® | Lay flat (cm) | (mil) |
| C1 | 0 | 0 | 0 | 8.0 | 2 to 3 |
| 2 | 2 | 0 | 0 | 8.5 | 1 to 2 |
| 3 | 4 | 0 | 0 | 8.5 | 1 to 2 |
| C4 | 0 | 1 | 0 | 5.3 | 3 to 4 |
| C5 | 0 | 2 | 0 | 6 | 2 to 3 |
| C6 | 0 | 0 | 1 | 6.3 | 2 to 3 |
| C7 | 0 | 0 | 2 | 6 | 3 to 4 |

Crystallinity of these blown film samples was tested using differential scanning calorimetry (DSC) using a TA Instruments (New Castle, Del.) Model Q1000 and operated on a 5 to 10 mg of sample with 10° C./minute heating from ambient to 250° C. (in the case of PLA melting at 150° C. to 180° C.). The first heat generates a crystallization exotherm when the polymer crystallizes and at higher temperatures an endotherm is generated when those crystals melt. The “J/g” for the endotherm minus the “J/g” for the exotherm is an approximate measure of the amount of crystallinity in the original sample expressed in “J/g”. There may be up to a ±10 J/g uncertainty in the analysis because of the difficulty in determining the base line of the calorimetry plot.

100 J/g may indicate approximately 100% crystalline PLA, based on descriptions in R. E. Drumright et al, Advanced Materials 2000 12, (23), p. 1841 and Z. Kulinski, et al, Polymer 2005, 46, pp.10290-10300. Lower J/g indicates less crystallinity, with the value of J/g roughly proportional to the % crystallinity.

TABLE 2

| | DSC Analysis | | |
|---|---|---|---|
| | | | Amount |
| Example | Exotherm (J/g) | Endotherm (J/g) | of crystallization (J/g) |
| C1 | 40.7 | 41.7 | 1 |
| 2 | 27.5 | 32.8 | 5.3 |
| 3 | 18.1 | 33.6 | 15.5 |
| C4 | 40.9 | 41.4 | 0.5 |
| C5 | 42 | 42 | 0 |
| C6 | 40 | 32 | 8 |
| C7 | 39 | 32 | 7 |

The results in Table 2 indicate significantly more crystallinity may be obtained when Mod-1 (a combination of behenamide and EBAGMA) is added to PLA-1 compared to unmodified PLA-1 or PLA-1 modified with EBAGMA.

To simulate how the blown films would behave in a double bubble orientation process or a sequential process of blowing a film and then uniaxial stretching, a simple stretching test was performed. Ribbons were cut from the films in the Machine Direction in the sizes (W0, Th0) shown below in Table 2 and marked at 1-cm intervals (L0) along the machine direction. The films were heated by direct contact on each film face with 110° C. plates over a length of 2 inches and then stretched uniaxially. The stretch rate provided about 14 inches of stretched film from a 2-inch wide zone of heated film in about 4 seconds. The final dimensions of the films were shown below as Wf, Thf and Lf (the new spacing between the marks). The stretch ratio was averaged as 700% (+/−100%). To test the shrink performance of the stretched films, samples of the stretched film were marked with 1 cm tick marks in the stretched direction, treated in one of three methods as described below, and then exposed to 70° C. water for 30 seconds. The shrinkage was determined by measuring the spacing between the tick marks after the exposure and reported as a percentage.

(1) No heat setting. The stretched samples were not heat treated prior to the shrink test.

(2) “Short” heat setting: Film samples were heat treated for 1.5 seconds by direct contact on both sides to 110° C. heaters while the films were constrained from moving (shrinking) in the stretch direction.

(3) “Long” heat setting: Other film samples were heat treated as described in (2) for 10 seconds (+/−0.5 seconds).

TABLE 3

| | | | | | | | | % Shrink | | |
|---|---|---|---|---|---|---|---|---|---|---|
| | W0 | Th0 | L0 | Wf | Thf | Lf | Stretch | Method | Method | Method |
| Example | (cm) | (mil) | (cm) | (cm) | (mil) | (cm) | ratio | (1) | (2) | (3) |
| C1 | 1.8 | 2.8 | 1 | 1 | 0.7 | 6.5 | 6.5 | 13 | | |
| C1 | 1.8 | 2.7 | 1 | 1 | 0.7 | 6.5 | 6.5 | | 11 | |
| C1 | 1.9 | 2.2 | 1 | 1 | 0.5 | 6.5 | 6.5 | | | 0 |
| 2 | 2 | 2.4 | 1 | 1.2 | 0.4 | 7 | 7 | 12 | | |
| 2 | 1.7 | 2.7 | 1 | 1.5 | 0.5 | 7 | 7 | | 7 | |
| 2 | NA | 2.7 | 1 | NA | 0.6 | 7 | 7 | | | 0 |
| 3 | 3 | 1.8 | 1 | 1.8 | 0.4 | 5.7 | 5.7 | 13 | | |
| 3 | 3 | 1.9 | 1 | 1.8 | 0.4 | 5.7 | 5.7 | | 6 | |
| 3 | 3 | 2.2 | 1 | 2 | 0.3 | 5.7 | 5.7 | | | 0 |

Non-heat set films all showed at least 12% shrink. Heat treatment for 10 seconds provided dimensionally stable films. For short duration heat treatment, the film of nonmodified PLA showed no real difference in shrink performance. The film samples containing Mod-1 gave desirably lower shrinkages at 70° C. when subjected to short heat setting times.

Crystallinity of the films after their stretching and before heat setting was measured and summarized in Table 4. Examples 2 and 3 showed higher crystallinity than unmodified PLA (Comparative Example C1). Compared to the unstretched samples in Table 2, the samples in Table 4 indicate that stretching can provide increased crystallinity.

TABLE 4

| | DSC Analysis | | |
|---|---|---|---|
| | | | Amount |
| Example | Exotherm (J/g) | Endotherm (J/g) | of crystallization (J/g) |
| C1 | 34.1 | 39.9 | 5.8 |
| 2 | 0 | 45 | 45 |
| 3 | 0 | 40 | 40 |

The crystallinity of samples of film that had been stretched 600%, 500%, and 500% (respectively for samples C1, 2, and 3) and then heat set under constraint at 110° C. for various time periods is summarized in Table 5. Compared to the stretched, non-heat-set samples in Table 4, the samples in Table 5 show that heat setting can increase crystallinity, particularly for unmodified PLA, which had much lower initial crystallinity. However, despite this increased crystallinity, samples of unmodified PLA had greater shrinkage than Examples 2 and 3, modified as described herein.

TABLE 5

| | | Heat set Duration (sec) | | |
|---|---|---|---|---|
| | | 1 | 5 | 10 |
| Composition | Stretch (%) | Crystallinity (J/g) | | |
| C1 | 600 | 61 | 53 | 38 |
| 2 | 500 | 53 | 25 | 67 |
| 3 | 500 | 46 | 51 | 55 |

Additional stretch/shrink tests were performed similarly using different heating and stretching parameters as summarized below.

Samples were stretched at 110° C. 4× to 6× and heat set at 140° C. for 1 second and tested for shrinkage by exposure to 70° C. water for 30 minutes.

TABLE 6

| Composition | First Sample | Second Sample |
|---|---|---|
| C1 | 5x stretch (5% shrink) | 5x stretch (7% shrink) |
| 2 | 4x stretch (2% shrink) | 6x stretch (5% shrink) |
| 3 | 4x stretch (0% shrink) | 5x stretch (0% shrink) |

Samples were stretched at 75° C. and either not heat or heat set at 140° C. for 1 second and tested for shrinkage by exposure to 70° C. air for 30 minutes.

TABLE 7

Shrinkage

| Composition | Stretch ratio | Not Heat Set | Heat set |
|---|---|---|---|
| C1 | 4x stretch | 10% | 5% |
| 2 | 4x stretch | 0 | 0 |
| 3 | 3.7x stretch | 3% | 0 |

These tests all showed reduced shrinkage for the examples of modified PLA compared to unmodified PLA, particularly with a short heat set time.

The modulus was tested at 70° C. in the machine direction (MD) of these compositions using an Instron and stamped-out dog-bone plaques of 0.188-inch test width, 0.87-inch test length and running at a rate of 1 inch/minute. Tensile testing of the original stretched films shows an increase in toughness as indicated by higher break strains.

TABLE 8

| | Modulus (Tangent at | | Strain at Break |
|---|---|---|---|
| Example | 0% strain) kpsi | Stress at Break (psi) | (%) |
| C1 MD | 585 | 8160 | 22 |
| C1 TD | 290 | 6885 | 13 |
| 2 MD | 367 | 8670 | 61 |
| 2 TD | 320 | 7140 | 60 |
| 3 MD | 275 | 7140 | 50 |
| 3 TD | 285 | 4590 | 50 |

While certain of the preferred embodiments of the present invention have been described and specifically exemplified above, it is not intended that the invention be limited to such embodiments. Various modifications may be made without departing from the scope and spirit of the present invention, as set forth in the following claims.

1. A blown film produced from a composition wherein
the composition comprises, based on the weight of the composition, about 50 to about 99.5% of a poly(hydroxyalkanoic acid), about 0.1 to about 40% of an ethylene ester copolymer, and about 0.05 to about 5% of a nucleator;
the ethylene ester copolymer comprises, based on the total weight of the ethylene ester copolymer, about 20 to about 95% of copolymerized units of ethylene, about 0.5 to about 25% of copolymerized units of one or more olefins of the formula CH₂═C(R¹)CO₂R², and 0 to about 70 weight % of copolymerized units of one or more olefins of the formula CH₂═C(R³)CO₂R⁴;
R¹ is hydrogen or an alkyl group with 1 to 6 carbon atoms;
R² is glycidyl;
R³ is hydrogen or an alkyl group with 1 to 8 carbon atoms;
R⁴ is an alkyl group with 1 to 8 carbon atoms, carbon monoxide, or combinations of two or more thereof; and
the nucleator is a carboxylic acid or derivative thereof that does not cause PHA depolymerization.

2. The film of claim 1 wherein the poly(hydroxyalkanoic acid) comprises polymerized units of one or more hydroxyalkanoic acids selected from the group consisting of 6-hydroxyhexanoic acid, 3-hydroxyhexanoic acid, 4-hydroxyhexanoic acid, 3-hydroxyheptanoic acid, glycolic acid, lactic acid, 3-hydroxypropionic acid, 2-hydroxybutyric acid, 3-hydroxybutyric acid, 4-hydroxybutyric acid, 3-hydroxyvaleric acid, 4-hydroxyvaleric acid, 5-hydroxyvaleric acid, and combinations of two or more thereof.

3. The film of claim 1 wherein the poly(hydroxyalkanoic acid) is selected from the group consisting of poly(glycolic acid), poly(lactic acid), poly(hydroxybutyric acid), poly(hydroxybutyric acid-hydroxyvaleric acid) copolymer, poly(glycolic acid-lactic acid) copolymer, and combinations of two or more thereof.

4. The film of claim 3 wherein the poly(hydroxyalkanoic acid) is poly(lactic acid).

5. The film of claim 4 wherein the poly(lactic acid) is a stereo complex of poly(D-lactic acid) and poly(L-lactic acid).

6. The film of claim 2 wherein the ethylene ester copolymer comprises, based on the total weight of the ethylene ester copolymer, about 40 to about 90% of copolymerized units of ethylene, about 3 to about 20% of copolymerized units of one or more esters of the formula CH₂═C(R¹)CO₂R², and about 3 to about 70% of copolymerized units of one or more esters of the formula CH₂═C(R³)CO₂R⁴.

7. The film of claim 6 wherein the ethylene ester copolymer comprises, based on the total weight of the ethylene ester copolymer, about 50 to about 80% of copolymerized units of ethylene, about 3 to about 17% of copolymerized units of one or more esters of the formula CH₂═C(R¹)CO₂R², and about 20 to about 35% of copolymerized units of one or more esters of the formula CH₂═C(R³)CO₂R⁴.

8. The film of claim 7 wherein the ethylene ester copolymer is selected from the group consisting of ethylene glycidyl methacrylate copolymer, ethylene butyl acrylate glycidyl methacrylate terpolymer, and combinations thereof.

9. The film of claim 8 wherein the ethylene ester copolymer is an ethylene butyl acrylate glycidyl methacrylate terpolymer.

10. The film of claim 6 wherein the nucleator is selected from the group consisting of aromatic carboxylic acid, aliphatic carboxylic acid, fatty acid alcohol, aliphatic carboxylic acid ester, aliphatic carboxylic acid amide, polycarboxylic acid, aliphatic hydroxycarboxylic acid, and combinations of two or more thereof.

11. The film of claim 8 wherein the nucleator is an aliphatic carboxylic acid amide of an aliphatic carboxylic acid and the acid has 10 to 30 carbon atoms.

12. The film of claim 9 wherein the nucleator is an aliphatic carboxylic acid amide of an aliphatic carboxylic acid and the acid has 16 to 26 carbon atoms.

13. The film of claim 11 wherein the aliphatic carboxylic acid amide is selected from the group consisting of aliphatic monocarboxylic acid amide, N-substituted aliphatic monocarboxylic acid amide, aliphatic carboxylic acid bisamides, N-substituted aliphatic carboxylic acid bisamide, and N-substituted urea, and combinations of two or more thereof.

14. The film of claim 12 wherein the aliphatic carboxylic acid amide is behenamide.

15. A blown film produced from a blend of, based on the total weight of the composition, about 67 to about 99% of the poly(lactic acid), about 0.5 to about 20% of ethylene butyl acrylate glycidyl methacrylate terpolymer or ethylene methacrylate glycidyl methacrylate terpolymer, and about 0.1 to about 3% an amide selected from the group consisting of aliphatic monocarboxylic acid amide, N-substituted aliphatic monocarboxylic acid amide, aliphatic carboxylic acid bisamides, N-substituted aliphatic carboxylic acid bisamide, and N-substituted urea, and combinations of two or more thereof.

16. The film of claim 15 wherein the composition comprises about 89 to about 99% of the poly(lactic acid), about 1 to about 10% of the ethylene butyl acrylate glycidyl methacrylate terpolymer, and about 0.25 to about 1% of the amide; and the amide is behenamide.

17. The film of claim 16 comprising at least one additional layer comprising a thermoplastic resin other than the blend.

18. A process for preparing a blown film comprising:
contacting a poly(hydroxyalkanoic acid) with a combination of a nucleator and an ethylene copolymer to produce a compound having a composition as recited in claim 2;
extruding the compound upward through a thin annular die opening as a melt to form a tube;
introducing air through the center of the die to inflate the tube and thereby causing it to expand at or above the melting point (Tm); and
cooling the tube by air blown through one or more chill rings surrounding the tube to produce a blown film comprising the compound.

19. The process of claim 18 further comprising
before the introducing step, heating the tube at a temperature above the Tg, but below the crystalline melting point, of the composition;
expanding the tube by internal gas pressure to induce transverse orientation;
drawing the tube to induce longitudinal orientation whereby a drawn tube is produced; and
optionally exposing the drawn tube to heat while under tension, thereby preventing the tube from shrinking during the heat treatment.

20. The process of claim 18 further comprising collapsing the drawn tube or the biaxially oriented tube to produce a flattened tubular film; slitting the tubular film to open the tube to produce an open film; and unfolding the tube to produce a flat film.

21. The process of claim 20 further comprising further uniaxially orienting the flat film by heating the film at a temperature above the Tg but below the crystalline melting point of the compound and stretching it in one direction; optionally heat setting the uniaxially oriented flat film by exposing it to heat while under tension; and cooling the flat film to provide a uniaxially oriented film.
